(19) United States
(12) Patent Application Publication
(10) Pub. No.: US 2019/0031051 A1
(43) Pub. Date: Jan. 31, 2019

(54) Vehicular Child Temperature Monitoring System

(71) Applicant: Aidyface Inc., Bethesda, MD (US)

(72) Inventors: Miriam Leaman, Bethesda, MD (US); Daniel Weiner, Bethesda, MD (US)

(21) Appl. No.: 16/045,019

(22) Filed: Jul. 25, 2018

Related U.S. Application Data
(60) Provisional application No. 62/539,075, filed on Jul. 31, 2017.

(51) Int. Cl. B60N 2/26; B60N 2/90; B60R 1/12; B60K 35/00; B60K 37/00

(52) U.S. Cl. CPC B60N 2/26; B60N 2/90; B60R 1/12; B60K 2350/1056; B60K 37/00; B60R 2001/1215; B60R 2300/205; B60K 35/00

(57) ABSTRACT

Systems for monitoring a temperature within a child safety seat and methods for sending and receiving temperature data indicative of a temperature within a child safety seat are described.

### CROSS-REFERENCED TO RELATED APPLICATIONS

This application claims priority to U.S. Provisional Patent Application No. 62/539,075 filed Jul. 31, 2017, the entirety of which is hereby incorporated by reference.

### BACKGROUND

Government regulations require parents to keep an infant in a rear-facing child safety seat (i.e. car seat) until the infant is two years old and/or until the infant exceeds the height or weight limits for the car seat. Many rear-facing child safety seats include high backs and side panels that obstruct a driver's view of the infant when the infant is in the car seat. As such, the infant is not readily visible to the driver of the vehicle unless the driver leans back over the front seat to check on the infant in the car seat.

In order to overcome this problem, some drivers attach a mirror to the headrest of the vehicle seat on which the rear-facing seat is sitting, so that the driver can observe the infant in the vehicle's rear-view mirror while the infant is in the car seat.

### SUMMARY

Example embodiments are described herein. Viewed from a first aspect, the disclosure provides a mirror device for use in a vehicle. The mirror device includes a frame, a mirror positioned within the frame, and a communication interface through which the mirror device is configured to receive temperature data indicative of a temperature within a child safety seat. The mirror device further includes an integrated display configured to provide an indication of the temperature data. Further, the mirror device includes a processor configured to cause the integrated display to provide the indication of the temperature data.

Viewed from a second aspect, the disclosure provides a system for a vehicle. The system includes a mirror device and a remote temperature device. The mirror device includes a communication interface through which the mirror device is configured to receive temperature data indicative of a temperature within a child safety seat. The mirror device also includes an integrated display configured to provide an indication of the temperature data. The remote temperature device includes a temperature sensor configured to measure the temperature within the child safety seat. The remote temperature device also includes a communication interface through which the remote temperature device is configured to send the temperature data to the mirror device.

Viewed from a third aspect, the disclosure provides another system for a vehicle. The system includes a display device and a remote temperature device. The display device includes a communication interface through which the display device is configured to receive temperature data indicative of a temperature within a child safety seat. The display device also includes a display configured to provide a numerical indication of the temperature data. The remote temperature device includes a temperature sensor configured to measure the temperature within the child safety seat. The remote temperature device also includes a communication interface through which the remote temperature device is configured to establish a communication link with the display device and to send the temperature data to the display device. The remote temperature device also includes an attachment component configured to removably attach the remote temperature device to a child safety seat.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a simplified block diagram of an example system, in accordance with example embodiments.

FIG. 2 is a simplified block diagram of an example remote temperature device, in accordance with example embodiments.

FIG. 3 is a simplified block diagram of an example display device, in accordance with example embodiments.

FIG. 4 is a conceptual illustration of an example mirror device, in accordance with example embodiments.

FIG. 5 is a conceptual illustration of an example remote temperature device, in accordance with example embodiments.

FIG. 6 is a conceptual illustration of another example remote temperature device, in accordance with example embodiments.

FIG. 7 is an example state diagram, in accordance with example embodiments.

FIG. 8 is a flow chart, in accordance with example embodiments.

FIG. 9 is another flow chart, in accordance with example embodiments.

### DETAILED DESCRIPTION

### I. Introduction

This description describes several example embodiments including, but not limited to, example embodiments pertaining to systems for monitoring a temperature within a child safety seat and methods for sending and receiving temperature data indicative of a temperature within a child safety seat.

By way of example, an example system may include a remote temperature device and a display device. The remote temperature device may include a temperature sensor configured to measure the temperature within a child safety seat, and may also include a communication interface through which the remote temperature device is configured to send temperature data to the display device. The display device, in turn, may include a communication interface through which the display device is configured to receive temperature data indicative of the temperature within the child safety seat, and a display configured to provide an indication of the received temperature data.

In operation, the remote temperature device may be attached to a child safety seat, such as a child safety seat that is positioned on a seat in a vehicle. For instance, the remote temperature device can be strapped, clipped, or otherwise attached to the child safety seat, and the temperature sensor can be inserted beneath a liner or cushion of the child safety seat. The remote temperature device may periodically measure the temperature within the child safety seat and send temperature data indicative of the temperature within the child safety seat to the display device. When the display device receives the temperature data, the display device may provide an indication of the received temperature data for display. In this manner, a driver or occupant of the vehicle can view the displayed indication and readily discern the temperature within the child safety seat.

Advantageously, the temperature within the child safety seat may be indicative of a body temperature of an infant sitting in the child safety seat. Thus, a driver or occupant of the vehicle can view the displayed indication to determine an estimate of the temperature of the infant. If the displayed indication indicates that the infant is overheating, the driver or occupant can then take action to lower the infant's temperature. For example, the driver may stop the vehicle and remove the infant from the child safety seat or decrease a temperature within the vehicle using a climate control system of the vehicle. Likewise, the displayed indication may also alert the driver that an infant that is too cold, so that that driver can take action.

Additional functionalities and examples of the described methods and systems are also described hereinafter with reference to the accompanying figures.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first”, “second”, “third”, and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### II. Example Architecture

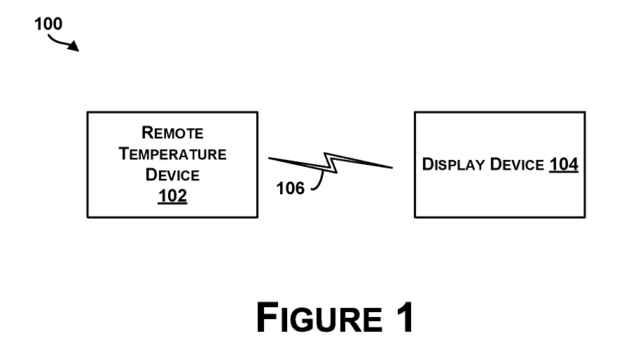

FIG. 1 is a simplified block diagram of an example system 100, in accordance with example embodiments. The system 100 includes a remote temperature device 102 and a display device 104.

Remote temperature device 102 may take any of a variety of forms, including for example a computing device having a temperature sensor and various other components. Remote temperature device 102 may be configured to be attached to a child safety seat and to measure a temperature within the child safety seat. In addition, remote temperature device 102 may be configured to send temperature data indicative of the measured temperature to display device 104. For instance, remote temperature device 102 may be configured to send a current temperature to display device 104 over the communication link 106 every second, ten seconds, minute, etc.

Display device 104 may also take any of a variety of forms, including for example a mirror device, a heads-up display, a rear-view mirror, a dashboard display, or some other type of computing device configured to display data. In some instances, display device 104 may be portable and releasably connected to a vehicle. For instance, display device 104 may be a mirror device that is attachable to a head-rest of a vehicle. Alternatively, display device 104 may be part of a vehicle.

Display device 104 may be configured to receive temperature data and to display an indication of the received temperature data. For instance, the display device 104 may periodically receive a temperature and provide a numerical indication of the temperature.

Various portions of this disclosure are described by way of example in the context of a display device in the form of a mirror device. It should be understood, however, that principles of the disclosure can extend to various other types of display devices as well, with variations where appropriate.

In system 100, remote temperature device 102 may communicate with display device 104 over communication link 106. Communication link 106 may take the form of a wireless connection, such as an IEEE 802.11 (Wi-Fi), BLUETOOTH®, or Zigbee wireless connection. Alternatively, communication link may take the form of a wireline connection, such as an Ethernet connection.

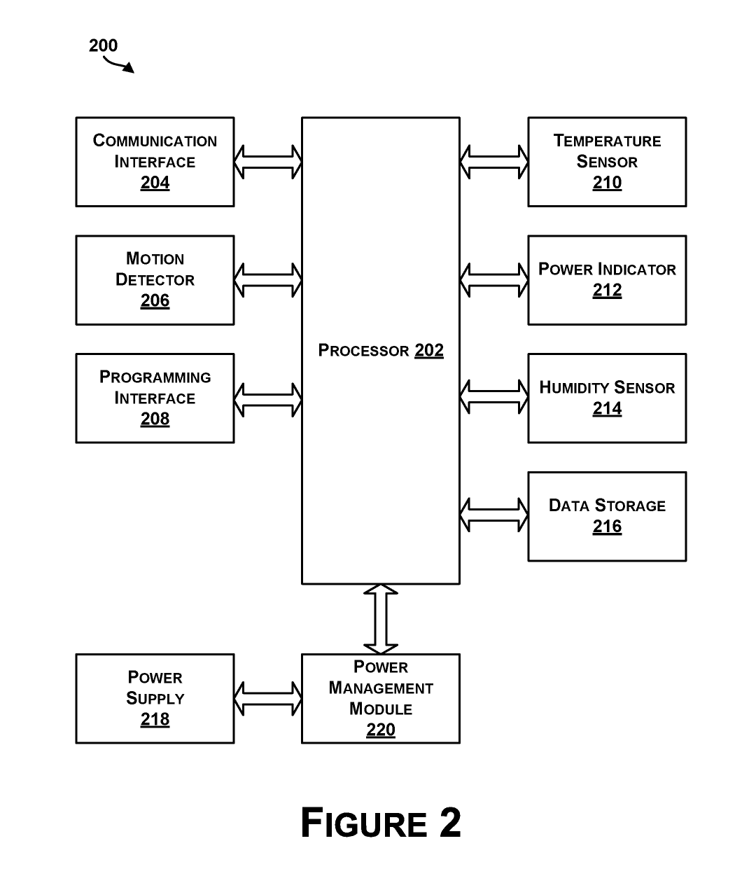

FIG. 2 is a simplified block diagram of an example remote temperature device 200, in accordance with example embodiments. Remote temperature device 200 may represent the remote temperature device 102 of FIG. 1. As shown in FIG. 2, remote temperature device 200 includes a processor 202, communication interface 204, motion detector 206, programming interface 208, temperature sensor 210, power indicator 212, humidity sensor 214, data storage 216, power supply 218, and power management module 220.

Depending on the desired configuration, processor 202 can be of any type including but not limited to a microprocessor (μP), a microcontroller (μC), a digital signal processor (DSP), or any combination thereof. Processor 202 may be configured to perform various functions. For instance, processor 202 may be configured to send temperature data to another device via communication interface 204. Additionally or alternatively, processor 202 may be configured to send humidity data and/or power data (e.g., battery capacity data) to another device via communication interface 204. Processor 202 may also be configured to periodically measure a voltage level of power supply 218 and provide an indication that the voltage level is low upon determining that the voltage level is below a threshold. For instance, processor 202 may be configured to cause power indicator 212 to provide an indication that the voltage level is low upon determining that the voltage level is below a threshold.

Communication interface 204 may include a wired and/or wireless communication interface. For purposes of this description, any data described as being provided, sent, or transmitted by remote temperature device 200 can be data sent by communication interface 204. Also, for purposes of this description, any data described as being received by remote temperature device 200 can be data sent to communication interface 204. By way of example, communication interface 204 may take the form of a radio frequency (RF) interface, such as a Wi-Fi or BLUETOOTH® interface.

Motion detector 206 may include an accelerometer or similar device configured to detect motion of remote temperature device 200. For instance, when remote temperature device 200 is in a vehicle and the vehicle is in motion, motion detector 206 may detect a magnitude and/or direction of the motion and output an indication of the motion. In one example, motion detector 206 may output a motion indication upon detecting a magnitude of motion that exceeds a threshold.

Programming interface 208 may include a serial interface or other interface that facilitates programming remote temperature device 200 or debugging.

Temperature sensor 210 may be configured to sense a temperature, and to output an analog or digital temperature signal. For instance, temperature sensor 210 can take the form of a thermocouple, thermistor, or semiconductor sensor. Temperature sensor 210 can be connected to processor 202 and/or data storage 216 by way of a wired or wireless connection.

Power indicator 212 may be configured to provide an audible and/or visual indication of a voltage level of the power supply 218. As one example, power indicator 212 may be a light-emitting diode that is configured to illuminate (e.g., blink) or change color when a voltage level of power supply 218 is below a threshold.

Humidity sensor 214 may be a hygrometer or other similar device configured to measure humidity.

Data storage 216 may include volatile or non-volatile storage components and may be integrated in whole or in part with processor 202. Data storage 216 may take the form of a non-transitory computer-readable medium and may include software program instructions, that when executed by processor 202, cause remote temperature device 200 to perform one or more of the operations described herein. For instance, data storage 216 may include software instructions for measuring a temperature within a child safety seat, and sending temperature data indicative of the measured temperature to another device. Any software program instructions discussed in this description or shown in the figures can be referred to as computer-readable program instructions, or more simply, program instructions.

Power supply 218 can include one or more batteries that provide power for the processor 202 and various other components of remote temperature device 200.

Power management module 220 may be configured to perform one or more power management functions, such as power monitoring, power conversion, and power state switching. By way of example, power management module 220 may be configured to switch remote temperature device 200 from a first power state (e.g., ON power state) to a second power state (e.g., sleep power state) that consumes less power than the first power state. Switching remote temperature device 200 from the first power state to the second power state may involve powering off one or more of the components of remote temperature device 200. For instance, power management module 220 may be configured to individually manage power for one or more of the components of remote temperature device 200. To switch from the first power state to the second power state, power management module 220 may switch from providing power to temperature sensor 210 to not providing power to temperature sensor 210. In some examples, power management module 220 may be integrated in whole or in part with processor 202. For instance, processor 202 may perform one or more of the power management functions.

In line with discussion above, remote temperature device 200 may be attached to a child safety seat, such as a rear-facing child safety seat of front-facing child safety seat that is positioned on a seat in a vehicle. In one embodiment, remote temperature device 200 may include a housing that houses processor 202 and other components of remote temperature device 200, and an attachment component can be coupled to the housing. For instance, the attachment component may be a releasable clip, such as a gear clip or carabiner. The releasable clip may be clipped to the child safety seat beneath a liner or cushion of the child safety seat. In one implementation, the releasable clip may be clipped to an unused harness slot in the child safety seat. Alternatively, the attachment component may be a strap that can be strapped to the child safety seat (e.g., strapped to a harness slot or strapped around another portion of the child safety seat).

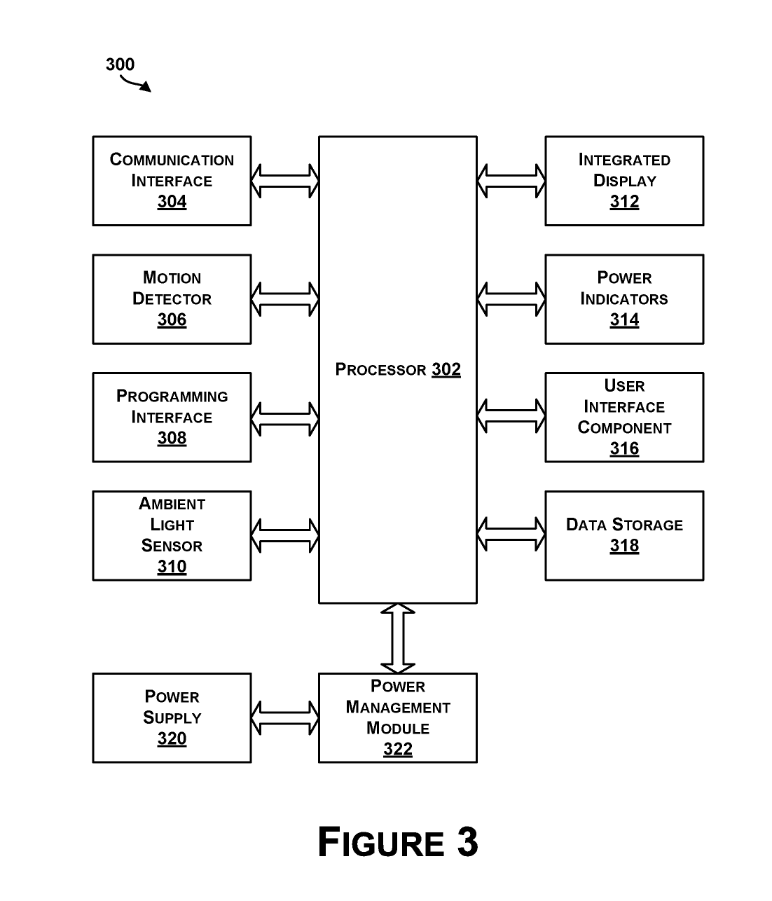

FIG. 3 is a simplified block diagram of an example display device 300, in accordance with example embodiments. Display device 300 may represent the display device 104 of FIG. 1. As shown in FIG. 3, display device 300 includes a processor 302, communication interface 304, motion detector 306, programming interface 308, ambient light sensor 310, integrated display 312, one or more power indicators 314, user interface component 316, data storage 318, power supply 320, and power management module 322.

Depending on the desired configuration, processor 302 can be of any type including but not limited to a microprocessor (μP), a microcontroller (μC), a digital signal processor (DSP), or any combination thereof. Processor 302 may be configured to perform various functions. For instance, processor 302 may be configured to receive temperature data from another device via communication interface 304. Additionally or alternatively, processor 302 may be configured to receive humidity data and/or power data (e.g., battery capacity data) from another device via communication interface 304. Processor 302 may also be configured to provide an indication of the received temperature data using integrated display 312. For instance, upon receiving temperature data, processor 302 may cause integrated display 312 to provide a numerical indication of the received temperature data.

Processor 302 may also be configured to provide an indication of a voltage level of power supply 320. For instance, processor 302 may periodically measure a voltage level of power supply 320 and provide an indication that the voltage level is low upon determining that the voltage level is below a threshold. As an example, processor 302 may be configured to cause one of power indicators 314 to provide an indication that the voltage level is low upon determining that the voltage level is below a threshold. Additionally or alternatively, processor 302 may be configured to provide an indication of a voltage level of another device that provides temperature data to display device 300. For instance, processor 302 may receive power data indicative of a voltage level of a power supply of the other device, determine that the voltage level is below a threshold, and cause one of power indicators 314 to provide an indication that the voltage level of the other device is low.

Communication interface 304 may include a wired and/or wireless communication interface. For purposes of this description, any data described as being provided, sent, or transmitted by display device 300 can be data sent by communication interface 304. Also, for purposes of this description, any data described as being received by display device 300 can be data sent to communication interface 304. By way of example, communication interface 304 may take the form of a radio frequency (RF) interface, such as a Wi-Fi or BLUETOOTH® interface.

Motion detector 306 may include an accelerometer or similar device configured to detect motion of display device 300. For example, when display device 300 is in a vehicle and the vehicle is in motion, motion detector 306 may detect a magnitude and/or direction of the motion and output an indication of the motion. In one example, motion detector 306 may output a motion indication upon detecting a magnitude of motion that exceeds a threshold.

Programming interface 308 may include a serial interface or other interface that facilitates programming display device 300 or debugging.

Ambient light sensor 310 may be configured to sense light, and to output an analog or digital ambient light signal. For instance, ambient light sensor 310 can take the form of a photodetector. In one example, processor 302 may use sensor data from ambient light sensor 310 to control a brightness of integrated display 312. By adjusting the backlighting of integrated display 312, processor 302 can conserve power.

Integrated display 312 may be a digital display, such as a light-emitting diode display, configured to display one or more digits. For instance, integrated display 312 may be configured to display a temperature reading. In one example, integrated display 312 may include backlighting, such that integrated display 312 is viewable in different lighting environments.

Power indicators 314 may be configured to provide an audible and/or visual indication of a voltage level of a power supply, such as power supply 320 or a power supply of another device. For example, power indicators 314 may be light-emitting diodes that are configured to illuminate (e.g., blink) or change color when a voltage level of a power supply is below a threshold.

User interface component 316 may include one or more switches, buttons, or other input components that facilitate control of display device 300. In one example, a user may utilize user interface component 316 to provide a selection of a temperature scale of display device and/or to switch a temperature scale of display device 300 (e.g., from Celsius to Fahrenheit or from Fahrenheit to Celsius).

Data storage 318 may include volatile or non-volatile storage components and may be integrated in whole or in part with processor 302. Data storage 318 may take the form of a non-transitory computer-readable medium and may include software program instructions, that when executed by processor 302, cause display device to perform one or more of the operations described herein. For instance, data storage 318 may include software instructions for receiving temperature data from another device, and causing integrated display 312 to provide an indication of the received temperature data. Any software program instructions discussed in this description or shown in the figures can be referred to as computer-readable program instructions, or more simply, program instructions.

Power supply 320 can include one or more batteries that provide power for the processor 302 and various other components of display device 300.

Power management module 322 may be configured to perform one or more power management functions, such as power monitoring, power conversion, and power state switching. By way of example, power management module 322 may be configured to switch display device 300 from a first power state (e.g., ON power state) to a second power state (e.g., sleep power state) that consumes less power than the first power state. Switching display device 300 from the first power state to the second power state may involve powering off one or more of the components of display device 300. For instance, power management module 322 may be configured to individually manage power for one or more of the components of display device 300. To switch from the first power state to the second power state, power management module 322 may switch from providing power to integrated display 312 to not providing power to integrated display 312. In some examples, power management module 322 may be integrated in whole or in part with processor 302. For instance, processor 302 may perform one or more of the power management functions.

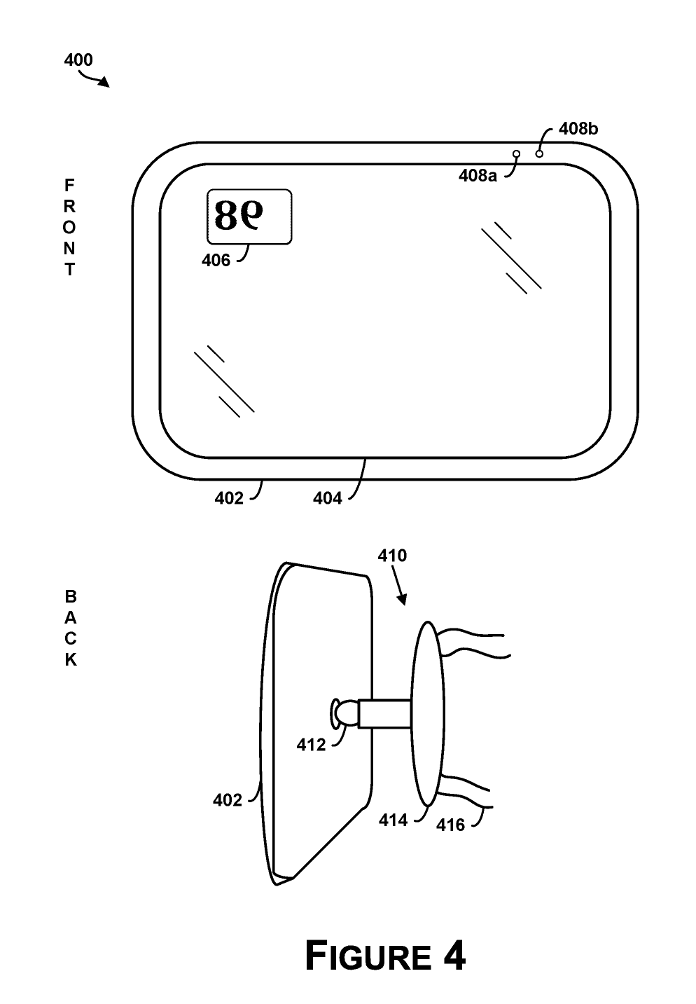

In line with the discussion above, display device 300 may take the form of a mirror device. FIG. 4 is a conceptual illustration of an example mirror device 400, in accordance with example embodiments. As shown in FIG. 4, mirror device 400 includes a frame 402, mirror 404, integrated display 406, power indicators 408a and 408b, and attachment component 410.

Frame 402 may, for example, be a plastic frame that holds mirror 404 in place. In addition, frame 402 may house one or more components of mirror device 400, such as a processor, communication interface, and power supply (not shown).

Mirror 404 may be a mirrored surface. In one example, mirror 404 may be made of a shatterproof material. Further, mirror 404 may also be convex-shaped.

Integrated display 406 may be a display configured to display one or more digits. As depicted, integrated display 406 is located within a section of mirror 404. In other examples, integrated display 406 may be located within frame 402. Further, the digits that integrated display 406 displays are mirrored, such that the digits have a proper orientation when viewed in a mirror (e.g., a rear-view mirror of a vehicle).

Power indicators 408a and 408b are depicted as light-emitting diodes. In one configuration, power indicator 408a may indicate a power status of a power supply of mirror device 400, while power indicator 408b may indicate a power status of a power supply of another device that provides temperature data to mirror device 400.

Attachment component 410 is configured for attaching mirror device 400 to a headrest of a vehicle seat or to another part of a vehicle. As shown in FIG. 4, attachment component 410 includes a ball joint 412, base 414, and straps 416. Ball joint 412 rotates for adjusting an orientation of mirror device 400. For instance, mirror device 400 may be rotated up, down, left, or right. Ball joint 412 is connected to base 414, which may be strapped to the headrest using straps 416. One of ordinary skill in the art will appreciate that other types of attachment components are also possible. For instance, in another embodiment, a mirror device may include another type of attachment component that facilitates attaching the mirror device to a different part of a vehicle than a headrest.

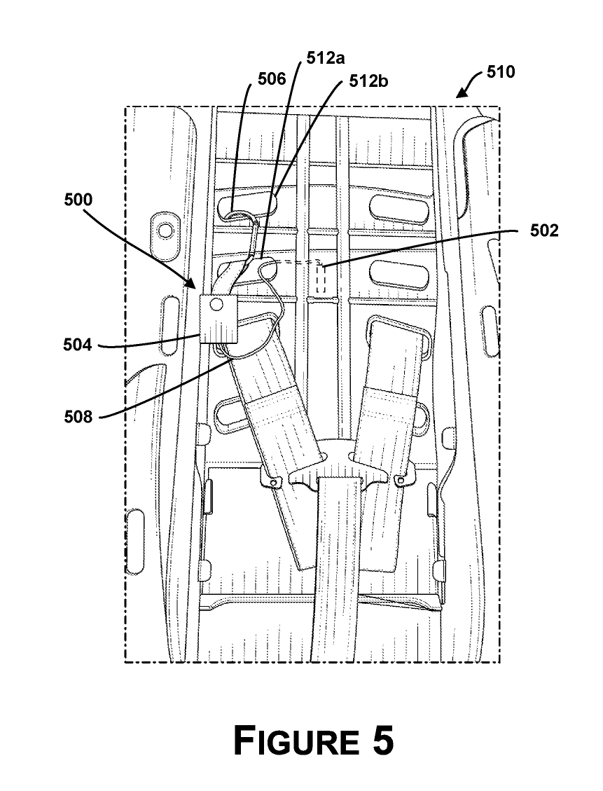

Further in line with the discussion above, remote temperature device 200 of FIG. 2 can include an attachment component for removably attaching remote temperature device 200 to a child safety seat. FIG. 5 is a conceptual illustration of an example remote temperature device 500, in accordance with example embodiments. As shown in FIG. 5, remote temperature device 500 includes a temperature sensor 502, housing 504, and attachment component 506.

Temperature sensor 502 is connected to housing 504 by way of a data cable 508, and is inserted beneath a liner of a child safety seat 510, between the liner and a frame of child safety seat 510. Data cable 508 is inserted through an unused harness slot 512a of child safety seat 512. Further, attachment component 506 is clipped between unused harness slot 510a and an unused harness slot 510b of child safety seat, thereby removably securing remote temperature device 500 to child safety seat 510.

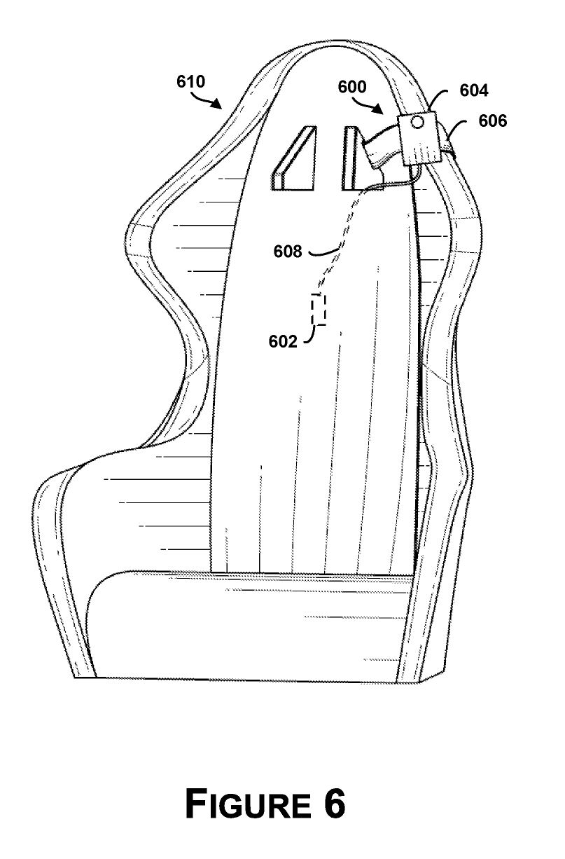

FIG. 6 is a conceptual illustration of an example remote temperature device 600, in accordance with example embodiments. As shown in FIG. 6, remote temperature device 600 includes a temperature sensor 602, housing 604, and attachment component 606. Temperature sensor 602 is connected to housing 504 by way of a data cable 508, and inserted beneath a liner of a child safety seat 610. Further, attachment component 606 is strapped to child safety seat 610, thereby removably securing remote temperature device 600 to child safety seat 610.

### III. Example Operations

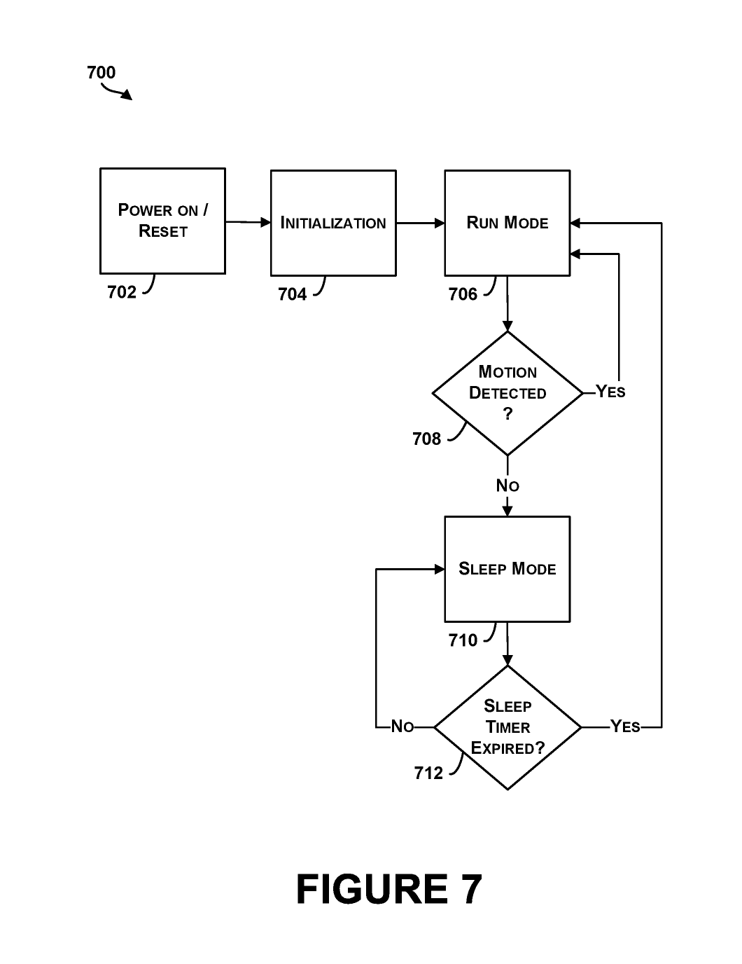

In some examples, the remote temperature device 102 and/or the display device 104 of FIG. 1 may operate in different power states. FIG. 7 is an example state diagram 700 indicating example power states that remote temperature device 102 or display device 104 may transition between. For ease of explanation, state diagram 700 is described with respect to a computing device. Computing device may be a remote temperature device or a display device.

As shown in FIG. 7, the computing device may power on or reset at block 702. Subsequently, at block 704, the computing device may perform one or more initialization processes. The initialization processes may involve establishing a communication link with another device. After performing the initialization processes, at block 706, the computing device may operate in a run mode. The run mode may correspond to a first power state. As an example, a display device operating in run mode may receive temperature data and display indications of the received temperature data. Similarly, in a run mode, a remote temperature device may measure temperatures and send temperature data to another device. For instance, in the run mode, the remote temperature device may measure a temperature every ten seconds, and then transmit temperature data indicative of the measured temperature to another device.

At block 708, while in the run mode, the computing device periodically determines whether motion is detected. For instance, a processor of the computing device may determine whether a motion detector has detected a magnitude of motion that exceeds a threshold. If so, the computing device may remain in the run mode. On the other hand, if the motion detector has not detected a magnitude of motion that exceeds the threshold, the computing device may transition to a sleep mode at block 710. The sleep mode may correspond to a second power state that consumes less power than the first power state. For instance, in a sleep mode, a display of a display device may be off. Similarly, in a sleep mode, a temperature sensor of a remote temperature device may be off.

Further, at block 712, while in the sleep mode, the computing device determines whether a sleep timer has expired. If so, the computing device switches back to run mode. On the other hand, if the sleep timer has not expired, the computing device remains in sleep mode.

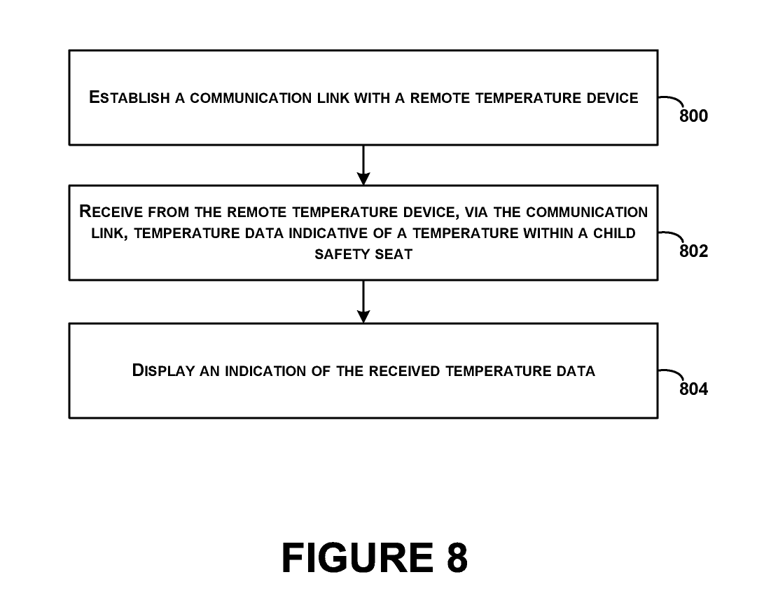

FIG. 8 is a flow chart showing a set of operations that can, for example, be carried out using a display device, such as the display device 104 of FIG. 1, the display device 300 of FIG. 3, or the mirror device 400 of FIG. 4.

Initially, block 800 includes establishing a communication link with a remote temperature device.

Next, block 802 includes receiving from the remote temperature device, via the communication link, temperature data indicative of a temperature within a child safety seat.

Next, block 804 includes displaying an indication of the received temperature data.

Additional blocks, not explicitly illustrated in FIG. 8, may involve determining that the mirror device is not in motion, and upon determining that the mirror device is not in motion, switching from a first power mode to a second power mode that utilizes less power than the first power mode. For instance, the mirror device may switch from a run mode to a sleep mode. Switching from the first power mode to the second power mode may involve powering off a display that provides the indication of the received temperature data.

Additional blocks may also involve, after switching from the first power mode to the second power mode, determining that the mirror device is in motion. And upon determining that the mirror device is in motion, switching from the second power mode to the first power mode.

The embodiments of FIG. 8 may be simplified by the removal of any one or more of the features shown therein. Further, these embodiments may be combined with features, aspects, and/or implementations of any of the previous figures or otherwise described herein.

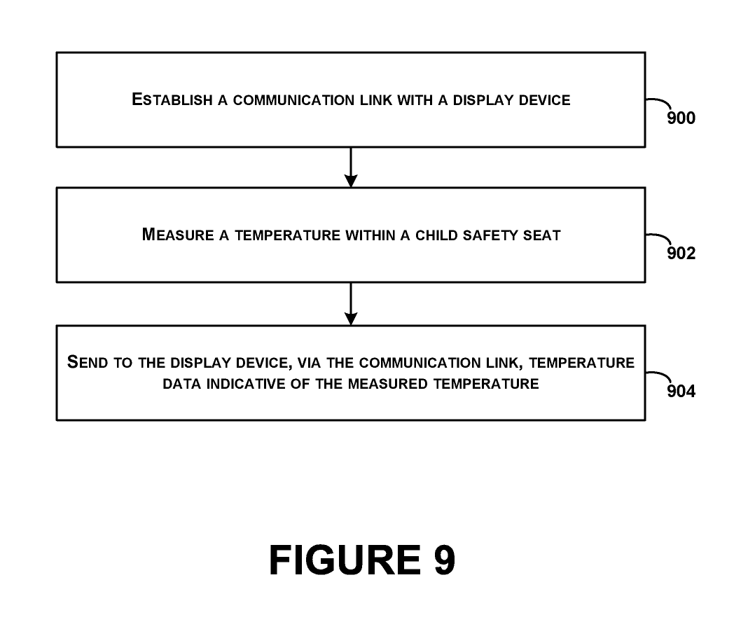

FIG. 9 is a flow chart showing a set of operations that can, for example, be carried out using a remote temperature device, such as the remote temperature device 102 of FIG. 1, the remote temperature device 200 of FIG. 2, the remote temperature device of 500 of FIG. 5, or the remote temperature device 600 of FIG. 6.

Initially, block 900 includes establishing a communication link with a display device. Display device can be a mirror device, a dashboard display, a rear view mirror, a heads-up display, or other type of computing device.

Next, block 902 includes measuring a temperature within a child safety seat.

Next, block 904 includes sending to the display device, via the communication link, temperature data indicative of the measured temperature.

Additional blocks, not explicitly illustrated in FIG. 8, may involve determining that the remote temperature device is not in motion, and upon determining that the remote temperature device is not in motion, switching from a first power mode to a second power mode that utilizes less power than the first power mode. For instance, the remote temperature device may switch from a run mode to a sleep mode.

Additional blocks may also involve, after switching from the first power mode to the second power mode, determining that the remote temperature device is in motion. And upon determining that the remote temperature device is in motion, switching from the second power mode to the first power mode.

The embodiments of FIG. 8 may be simplified by the removal of any one or more of the features shown therein. Further, these embodiments may be combined with features, aspects, and/or implementations of any of the previous figures or otherwise described herein.

### IV. Conclusion

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the invention can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

What is claimed is:

1. A mirror device for use in a vehicle, the mirror device comprising:
a frame;
a mirror positioned within the frame;
a communication interface through which the mirror device is configured to receive temperature data indicative of a temperature within a child safety seat;
an integrated display configured to provide an indication of the temperature data; and
a processor configured to cause the integrated display to provide the indication of the temperature data.

2. The mirror device of claim 1, further comprising an attachment component for attaching the mirror device to a vehicle seat of the vehicle.

3. The mirror device of claim 2, wherein the attachment component comprises a strap for attaching the mirror device to a headrest of the vehicle seat.

4. The mirror device of claim 1, wherein the integrated display is located within a section of the mirror.

5. The mirror device of claim 1, wherein the integrated display is located within the frame.

6. The mirror device of claim 1, wherein the integrated display is configured to provide a numerical indication of the temperature data using one or more mirrored digits.

7. The mirror device of claim 1, further comprising:
a motion detector configured to detect motion of the mirror device; and
a power management module configured to control a power state of the mirror device based on the motion of the mirror device.

8. The mirror device of claim 1, further comprising a user interface component through which the mirror device is configured to receive a selection of a temperature scale for the mirror device.

9. The mirror device of claim 1, further comprising an ambient light sensor, wherein the processor is further configured to use sensor data from the ambient light sensor to control a brightness of the integrated display.

10. A system for a vehicle, the system comprising:
a mirror device comprising:
a communication interface through which the mirror device is configured to receive temperature data indicative of a temperature within a child safety seat, and
an integrated display configured to provide an indication of the temperature data; and
a remote temperature device comprising:
a temperature sensor configured to measure the temperature within the child safety seat, and
a communication interface through which the remote temperature device is configured to send the temperature data to the mirror device.

11. The system of claim 10, wherein the remote temperature device further comprises an attachment component configured to removably attach the remote temperature device to the child safety seat.

12. The system of claim 11, wherein the temperature sensor is configured to be inserted beneath a liner of the child safety seat.

13. The system of claim 12, wherein the attachment component is configured to removably attach the remote temperature device to an unused harness slot of the child safety seat.

14. The system of claim 10, wherein the remote temperature device further comprises:
a motion detector configured to detect motion of the remote temperature device; and
a power management module configured to control a power state of the remote temperature device based on the motion of the remote temperature device.

15. The system of claim 10, wherein the mirror device is portable and configured to be releasably connected to the vehicle.

16. A system for a vehicle, the system comprising:
a display device comprising:
a communication interface through which the display device is configured to receive temperature data indicative of a temperature within a child safety seat, and
a display configured to provide a numerical indication of the temperature data; and
a remote temperature device comprising:
a temperature sensor configured to measure the temperature within the child safety seat,
a communication interface through which the remote temperature device is configured to establish a communication link with the display device and to send the temperature data to the display device, and
an attachment component configured to removably attach the remote temperature device to the child safety seat.

17. The system of claim 16, wherein the temperature sensor is configured to be inserted beneath a liner of the child safety seat.

18. The system of claim 16, wherein the display device comprises a dashboard display.

19. The system of claim 16, wherein the display device comprises a rear view mirror.

20. The system of claim 16, wherein the display device comprises a heads-up display.
